(19) United States
(12) Patent Application Publication
(10) Pub. No.: US 2026/0310381 A1
(43) Pub. Date: Oct. 8, 2026

(54) METHODS AND SYSTEMS USING MULTI-ITEM CONTAINERS IN PAGED DIRECT MAPPING KEY-VALUE STORES

(71) Applicant: QiStor Inc., San Jose, CA (US)

(72) Inventor: Andrew John TOMLIN, San Jose, CA (US)

(73) Assignee: QiStor Inc., San Jose, CA (US)

(21) Appl. No.: 19/481,658

(22) PCT Filed: Aug. 6, 2024
(86) PCT No.: PCT/US2024/041074

§ 371 Date: Nov. 5, 2025

Related U.S. Application Data
(60) Provisional application No. 63/518,243, filed on Aug. 8, 2023.

(51) Int. Cl. G06F 3/06

(52) U.S. Cl. CPC G06F 3/0656; G06F 3/0608; G06F 3/0679

(57) ABSTRACT

A computer-implemented method of implementing a Key-Value store may include iteratively receiving Key-Value data that includes a Key and a data Value and determining whether the Value data is a small Value data that is smaller than a predetermined threshold or a non-small Value data. When the Value data is determined to be a small Value data, a small Value header may be prepended to the small Value data and both may be temporarily stored in a buffer. When the Value data is determined to be a non-small Value data, a single piece of metadata may be generated and both may be sent to the media for storage. The buffer may be selectively flushed, whereupon the flushed small Value data and the prepended small Value headers may be compressed as a single unit and configured as a Multi-Item Container with a separate header. A separate piece of metadata may be generated for each small Value data in the Multi-Item Container and the Multi-Item Container may then be sent for storage to the media.

### BACKGROUND

Disk and flash storage devices such as Hard Disk Drives and Solid State Drives provide block-based storage via their interfaces. As shown in FIG. 1A, block-based storage devices have standardized logical interfaces to map fixed-size blocks 102, typically 512 bytes or 4096 bytes of data, to a logical block address (LBA) 104. Examples of these interfaces include NVMe, SATA and SCSI.

One of the Key challenges in storage systems is that real-world data often does not neatly fit into the fixed-size logical blocks provided by such block-based storage devices. To address this, systems implement additional hierarchical mapping mechanisms in software, enabling efficient storage of real-world data that can have a size granularity down to 1 byte.

A common storage mapping interface abstraction that is used to map variable-sized pieces of user data is known as Key-Value, as shown in FIG. 1B. This abstraction provides an application-friendly interface to the storage system by associating each piece of data (the Value) 108 with a unique identifier (the Key) 106, a user-defined reference. As the Key 106 is user-defined, it is an abstraction that does not rely on the physical location of the data, which is a problem delegated to lower levels. In this system, the user supplies both the Key 106 and the Value data 108 for storage operations, while for retrieval operations, the user provides the Key 106, and the system returns the corresponding Value data 108. This Key-Value mapping allows for rapid and efficient data access, as the Key 106 directly links to the Value data 108. The simplicity and versatility of Key-Value stores enable them to handle a wide variety of data types, making them particularly suitable for scalable and adaptable data management solutions. These characteristics render Key-Value stores a fundamental component in contemporary data storage and retrieval systems, providing significant performance benefits and operational efficiency.

To further contrast LBA and Key-Value, the LBA 104 is a device-supplied reference to a fixed-size block 102 in a linear address space 105, while Key-Value is a user-supplied reference to a variable-sized block of data. The Key 106 is a number of user-defined bytes of user-defined length (up to a maximum number), and importantly, unlike an LBA-style mapping system, the Key 106 does not necessarily reference a contiguous set of addresses.

While convenient for applications, Key-Value mapping systems present several implementation challenges that a simple LBA mapping scheme does not. These include:
the Key is not fixed in size;
the Key is user-defined;
the mapping space is not contiguous;
the Value is variable sized, and
a variable number of Key-Value data may exist in a predetermined storage capacity.

Any Key-Value mapping system must address these issues. Most solutions use hierarchical mapping systems, hash tables, tree structures, and other algorithms to track the location of data. The solutions space is much simpler if all the mapping data can fit into memory. For many solutions, however, not all the mapping information can be fitted into memory, so it must be paged in and out, which incurs a time penalty.

### BRIEF DESCRIPTION OF THE DRAWINGS

FIG. 1A is a diagram of a conventional logical block address based data storage system.

FIG. 1B is a representation of a Key-Value store system.

FIG. 2 shows a basic diagram of a Key-Value based data storage system that may be configured according to embodiments.

FIG. 3 illustrates the difference between compressing individual data items and compressing a single combined unit made up of the individual data items, according to embodiments.

FIG. 4 shows a Multi-Item Container according to an embodiment.

FIG. 5 is diagram illustrating various aspects of embodiments and showing the data path associated with a Multi-Item Container, according to embodiments.

FIG. 6 is a block diagram showing the manner in which Keys may be checked for duplicates, according to embodiments.

FIG. 7 is a flowchart of a computer-implemented method of operating a Key-Value store for efficient handling of small Value data, according to embodiments.

FIG. 8 is a block diagram of a computer system with which aspects of the embodiments described herein may be practiced.

### DETAILED DESCRIPTION

FIG. 2 shows a system in which a storage device 202 stores a full set of mapping data 204 and user data 206. The full mapping data 204 may be significantly larger than the portion 210 of mapping data that can fit in memory 208. As the full mapping data 204 may be too large to load in its entirety in the memory 208, only a portion 210 of the full mapping data 204 may be paged into the memory 208. Indeed, in a paged mapped Key-Value storage system, mapping information must be stored and retrieved between memory 208 and storage devices 202 during normal operation.

One significant difference between managing fixed-sized blocks in regular storage and Key-Value storage is that the number of objects contained within a Key-Value store is variable. This means that the metadata storage system must also grow in proportion to the number of stored objects and thus must be dynamic in size.

In any solution where searching is avoided (i.e., one read of metadata and one read to the media), there should be a guarantee that there exists a unique piece of mapping information for each Key. This unique mapping information can avoid more than two reads while retrieving data to find the most up-to-date Key-Value. However, the amount of mapping information in this case is much bigger and can be an issue. In such a system, however, it is guaranteed that a maximum of one read will page in the correct mapping data, and that only one read need be performed to access the data referenced by the Key.

The size of the mapping information becomes a critical problem for a mapping system suitable for managing Key-Value data. There is a tradeoff between the accuracy of location information and the need for searching. Current state-of-the-art solutions include Log Structure Merge (LSM), in which location information may be highly abstracted, most often requiring multiple reads and search operations to locate the data, including potentially stale copies. Solutions like Log Structure Merge can result in more than two reads, and those reads can be much larger than the Value data of interest.

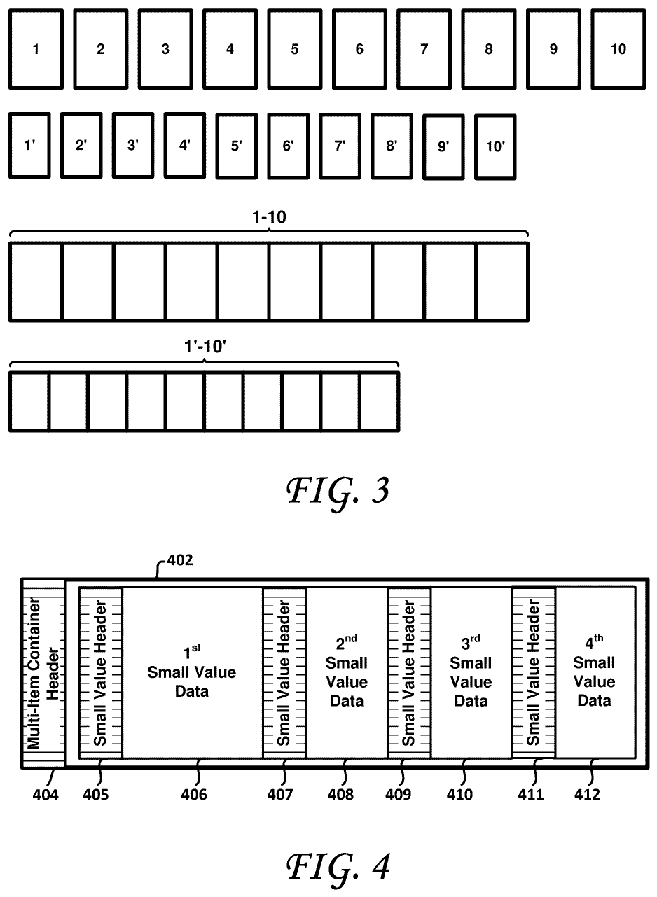

LSM stores multiple Value data together in a file. While this impacts read efficiency, it does have one key benefit over 1-to-1 metadata data mapping schemes, which becomes apparent when handling many small Value data. The file-based nature of LSM and the fact that multiple Value data are stored together means they can be compressed much more efficiently than individually compressed Value data. This is because compression relies on eliminating redundancy within a data set, which results in some compression startup efficiency loss. This compression startup efficiency loss is especially onerous when compressing small Value data. For example, as shown in FIG. 3, ten individual 256-byte items 1-10 are individually compressed into 10 corresponding compressed items 1′ through 10′, yielding some size reduction. In contrast, if these 10 individual 256 bytes items were concatenated into a single unit of 2560 bytes and compressed as a single unit, the concatenated 2650 byte single unit 1-10 will necessarily compress, as shown at 1′-10′, to a smaller byte size than the aggregate byte size of 10 individually compressed items 1′ through 10′. In the latter case (the concatenated single unit 1-10 compressed to 1′-10′), the startup efficiency loss only occurs once, and any redundancy between items is also compressed. It should be noted that larger Value data do not exhibit this issue, as compression efficiency levels out as the Value data items being compressed become larger.

The Multi-Item Container according to the embodiments shown and described herein provides the same advantage of compressing multiple small items together without the downsides of Log Structured Merge in which multiple Value data are stored together in a file. Small Value data are defined as Value data whose length is below a predetermined size. The upper limit of such a “predetermined size” is a matter of design choice and may vary according to the implementation.

According to one embodiment, multiple independent small Value data may be compressed as one unit and stored together in a Multi-Item Container and managed together as a collective unit. Such a Multi-Item Container may be configured, according to an embodiment, such that the Multi-Item Container itself has its own Multi-Item Container Header, and each contained small Value data has its own Small Value Header. This is shown in the FIG. 4, in which a Multi-Item Container 402 includes a Multi-Item Container Header 404 and a plurality of small Value data 406, 408, 410 and 412, each with its own Small Value Header 405, 407, 409 and 411. In one implementation, the Multi-Item Container Header 404 may be configured to contain the header type (e.g., multi) and the compressed length of the container. Each of the Small Value Headers 405, 407, 409 and 411 may be configured to contain the Key corresponding to the small Value data, the Cyclic Redundancy Check (CRC), and the uncompressed length of the small Value data.

The metadata for all of the small Value data 406, 408, 410 and 412 contained in the Multi-Item Container 402, according to one embodiment, reference the location of the Multi-Item Container 402, and not the location of the small Value data themselves. Therefore, packaging several small Value data 406, 408, 410 and 412 in a Multi-Item Container requires that several issues be addressed.

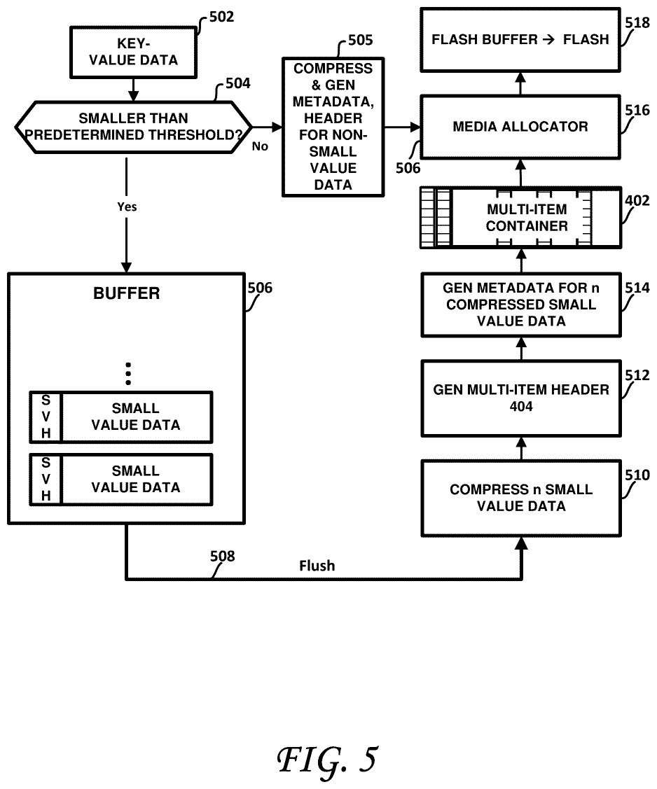

Small Value data, such as shown at 406, 408, 410 and 412, according to one embodiment, may not be written immediately to the media but may instead be buffered in memory to allow accumulation and storage in memory of other small Value data. FIG. 5 is a block diagram showing the data path associated with non-small Value data, as well as the creation and storage of small Value data in Multi-Item Containers 402, according to an embodiment. As shown in FIG. 5, the size of the Value data 502 (specified by a write command, for example) may be checked at 504 to determine if the size of the Value data is smaller than a predetermined threshold. If the size of the Value data 502 is determined at 504 to be equal to or larger than the predetermined threshold, the non-small value is compressed and a header and metadata for the non-small Value data may be generated and the non-small Value data and its header may be forwarded to a Media Allocator 516, which assigns a storage location to the non-small Value data and its associated header (and, as discussed below, to Multi-Item Containers) in the storage media. Larger size (i.e., non-small) Value data, in this manner, is forwarded to a flash buffer and thereafter to flash media, as shown at 518, along the normal data path. If, however, the size of the Value data 502 is determined at 504 to be less than the predetermined threshold (and thus qualifies as being a small Value data), the small Value data may be forwarded to an in-memory buffer 506, where it is paired with a Small Value Header (as shown at 405, 407, 409 and 411 in FIG. 4), and temporarily stored. A number n of Small Value Headers and Value data pairs are, therefore, temporarily accumulated in the buffer 506 until they are flushed, as a group (which may be as small as a single small Value data), to be compressed at 510 as a unit. Indeed, the compressor 510 does not compress each of the accumulated Value data individually but treats the n accumulated Value data and their respective Small Value Headers as a single data packet and compresses the group of n Value data-Small Value Headers pairs together, as a unit, thereby compressing the group to a greater degree than would be possible if the compression was carried out individually for each small Value data.

As shown in FIG. 5 and according to an embodiment, after the n small Value data and their respective Small Value Headers are compressed as a group, the Multi-Item Header 404 may be generated at 512. The Multi-Item Container Header 404, according to an embodiment, may comprise a header type field (in this case, “multi”) and the overall compressed length of the group of n compressed Value data 406, 408, 410 and 412 and their respective Small Value Headers 405, 407, 409 and 411. At reference 514 in FIG. 5, the metadata for the n compressed Small Value data 406, 408, 410 and 412 may be generated. Recall that normal Value data, whose size is equal to or larger than the predetermined size, generates a single metadata element (e.g., including location and size). However, the generation of the metadata for a Multi-item Container 402, as shown at reference 414 in FIG. 4 and according to embodiments, generates n items of metadata, each including size and location, one item of metadata being generated for each of the n small Value data in the Multi-Item Container 402. Recall that the metadata for all of the small Value data 406, 408, 410 and 412 contained in the Multi-Item Container 402, according to one embodiment, reference the location of the Multi-Item Container 402, and not the location of the small Value data themselves. Also note that the Small Value Headers (comprising the Key, CRC, and uncompressed length of their associated Small Value data), once compressed, are not readable until they are decompressed.

Continuing, the Multi-Item Container 402 generated in this manner may then be forwarded to the Media Allocator 516, which determines the location where the Multi-Item Container 402 is to be stored in the media, whereupon the Multi-Item Container 402 may be forwarded to a Flash Buffer for eventual storage in a Flash media storage device.

The storage of small Value data in the Multi-Item Container 402 may result in coherence issues if the same Key-Value pair is the subject of multiple write commands prior to the reported completion of the first in time write command. It should be noted that the NVMe KV standard does not guarantee coherence between commands that have not had a completion status sent. For an implementation that delays the completion until writes are sent to the media, these corner cases do not cause any issues. However, if the completion status is returned before writing to the media, which is desirable for lower latency, then the coherence problem must be managed.

Assuming the command completion status is returned before the Multi-Item Container 402 is stored on the media itself, there are two types of coherence issues:
1. Coherence between two commands with the same Key, where the first command has a small Value data and the second command has a large Value data, and
2. Coherence between two commands with the same Key, where the first command has a small Value data and the second command also has a small Value data.

There are no coherence issues between two commands with the same Key where the first command has a large Value data and the second command has a small Value data, because the large Value data and the small Value data do not follow the same path and ordering is unchanged, with the large Value data being sent directly to the Media Allocator 516 in the normal data path and the small Value data being temporarily buffered in the Multi-Item Container 402. The potential coherence problem occurs between a small Value Data and a large Value data because the order in which the Value data are processed can be reversed, such that the second command with the large Value data may be stored in the media before the first command small Value data is stored in the media. In this case, the coherence between the Value data must be explicitly managed.

Multiple small Value data can be handled, either during the write process by eliminating stale Key-Value data or during the read by getting the latest entry after decompression. Implementation issues will dictate which of these solutions is preferable.

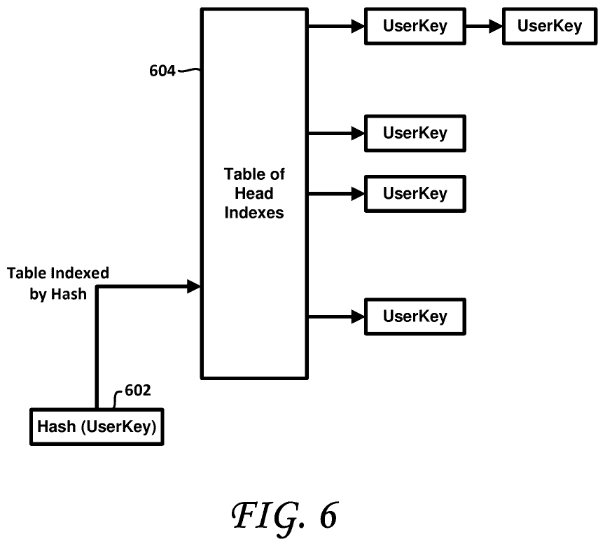

There are several methods to perform this coherence management, such as sorted lists. According to one embodiment, however, a small hashing table may be used for purposes of coherence management. The system is already generating hashes (such as to page in a portion of the metadata mapping data from storage to memory), so the overhead in generating hashes for this purpose is not too costly. The capacity of such a hashing solution is constrained to the set of Keys in the Multi-Item Container. A subset of the system-level hash can be used as the index into the hash table. Hash space may be expanded to reduce hash collisions, and collisions can be managed via lists. Alternative hashing algorithms are well documented in the literature and may be selected according to the implementation. FIG. 6 is a block diagram of a simple hash and collision list, illustrating one method for identifying duplicates from the Keys that are present in the Multi-Item Container.

As new Keys arrive, for either read or write commands, a hash table can be quickly checked for matches of identical Keys. As shown in FIG. 6, a hash 602 of a UserKey may be used to index into a hash table 604 to determine whether a matching UserKey exists that has not yet been flushed from the buffer. If there is a match of a Key on a write command, then the small Value data in the Multi-Item Container 402 corresponding to the matching Key may be deleted, if possible, or marked as invalid depending on other implementation details. If the command is a read command, the small Value data in the buffer 506 corresponding to the matching Key may be returned. In one embodiment, a flush may be forced whenever a matching Key is determined to be present in the buffer 506. As it is expected for this situation to be rare, a flush on match can simplify the overall implementation.

As noted above, however, the generation of the metadata for a Multi-item Container 402 at reference 514 in FIG. 4 generates n items of metadata, each including size and location, one item of metadata for each of the n small Value data in the Multi-Item Container 402. The Multi-Item Container Header (shown at 404 in FIG. 4) contains the header type and the compressed length of the Multi-Item Container 402. When the n items of metadata are generated, the size of the compressed Multi-Item Container 402 may be apportioned amongst the small Value data contained within the Multi-Item Container 402, according to the size of each of the small Value data. It is important to track the length (size) of the small Value data correctly. Indeed, tracking the correct size of the small Value data is necessary to accurately carry out free space accounting, which is inherent in the normal operation of any mapping system. For non-small Value data items, the individually compressed size of the (larger) Value data is tracked in the metadata. This is not possible for the constituent small Value data of a Multi-Item Container 402, as multiple small Value data and their respective Small Value Headers are compressed together as a unit. To be clear, before compression, the size of each small Value data in the Multi-Item Container 402 is known, as the uncompressed length of the small Value data is stored in its corresponding Small Value Header. However, after compression, only the aggregate compressed size of all the contained compressed Value data and their respective Small Value Headers is known. There are two options to address this issue.

The first option, according to an embodiment, is to variably apportion the compressed space amongst the items in the Multi-Item Container based on their uncompressed size, or to apportion the compressed space evenly amongst all the items in the Multi-Item Container. According to another embodiment, the second option, at the free space accounting level, is to separately keep track of both compressed and uncompressed space of the Multi-Item Container and store the uncompressed size in the metadata mapping system.

According to another embodiment, if the implementation at hand is configured to only send write completions until after Value data are safely written to media, a timeout flushing mechanism may be implemented. Such a timeout flushing mechanism ensures that if additional small Value data items are not received in the buffer 506 within a predetermined time window, a flush is automatically carried out, which results in the compression of however many small Value data and Small Value Headers were present in the buffer 506, the generation of the Multi-Item Container header, the creation of a Multi-Item Container and the generation of n pieces of metadata (one piece for each small Value data flushed) and the eventual storage of the Multi-Item Container in Flash, thereby causing the write completion. In this manner, write completion is not indefinitely delayed waiting for the eventual arrival of small Value data.

When the temporarily stored small Value data and prepended Small Value Headers are flushed at 508—either due to normal filling or any other situation (such as the timeout flushing mechanism discussed immediately above), compressed as a unit and the Multi-Item Header generated to form the Multi-Item Container 402, the metadata for all n contained Keys is generated and sent to the rest of the system. Assuming the Multi-Item Container's size is always less than a single read addressable unit (in one implementation, 8 KB or an integer multiple thereof), then the required read size can always be generated regardless of which of the length tracking methods are used. The location stored for all the Keys will be the same and will be based on the location of the Multi-Item Container Header of the Multi-Item Container.

In the read process, if a Multi-Item Container is discovered, it will be decompressed to allow the location of the small Value data item corresponding to the provided Key to be ascertained.

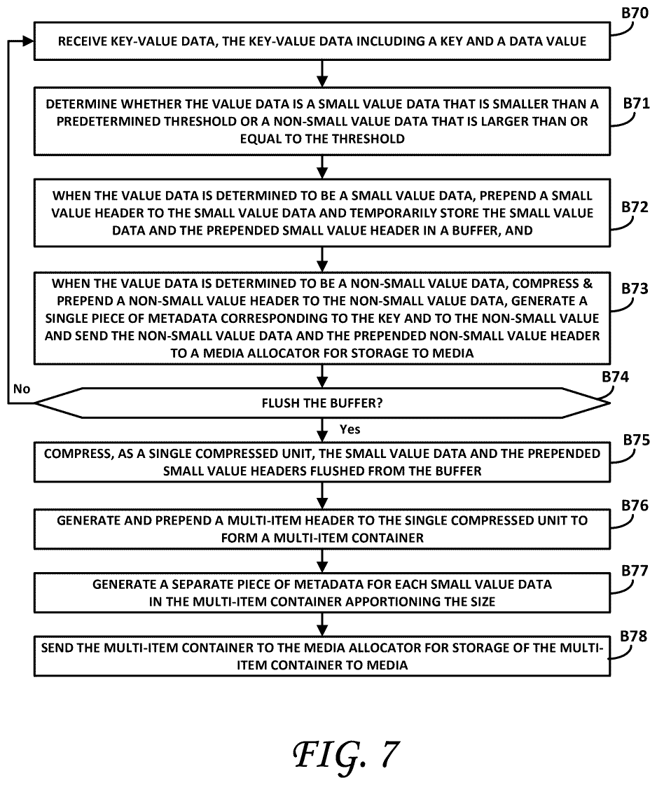

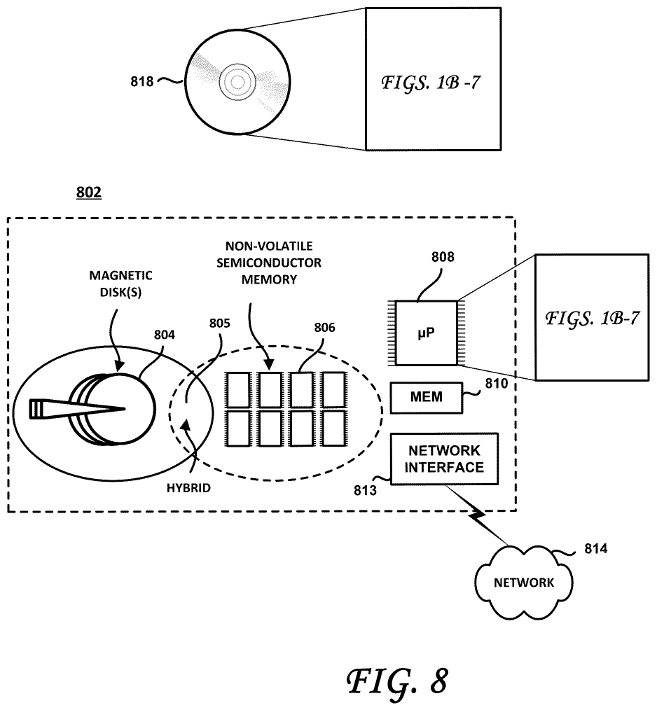

FIG. 7 is a flowchart of a computer-implemented method of implementing a Key-Value store according to an embodiment. As shown therein, block B70 calls for receiving Key-Value data, with the Key-Value data including a Key and a Value data. At B71, it is determined whether the received Value data is a small Value data that is smaller than a predetermined threshold or a non-small Value data that is larger than or equal to the threshold. As shown at B72, when the Value data is determined to be a small Value data, a small Value header may be added to the small Value data and the small Value data and the small Value header may be temporarily stored in a buffer. On the other hand and as shown at B72, when the Value data is determined to be a non-small Value data, it is compressed and a non-small Value header may be added to the non-small Value data, and a single piece of metadata corresponding to the Key and to the non-small Value may be generated and sent to the metadata mapping system. The non-small Value data and the non-small Value header may then be sent to a media allocator for storage to media. At B74, it is determined whether to flush the buffer. Such determination may be made, for instance, for coherence purposes or because a predetermined number n of small Value data has already been buffered. If the buffer is not to be flushed (“No” branch of B74), the present computer-implemented method may revert back to block B70. If, however, the buffer is to be flushed (“Yes” branch of B74), the entire contents of the buffer may be flushed and the small Value data and the small Value headers flushed from the buffer may be compressed as a single compressed unit, as shown at B75. A Multi-Item header may then be added to the single compressed unit to form a Multi-Item Container, as shown at B76. Significantly, a separate piece of metadata for each small Value data in the Multi-Item Container may be generated apportioning the size and sent to the metadata mapping system for tracking, as shown at B77. The Multi-Item Container, as shown at B78, may be sent to the media allocator, to enable the Multi-Item Container to be stored to media.

According to further embodiments, the small Value header may comprise a Key corresponding to the small Value data, a Cyclic Redundancy Check (CRC) and an uncompressed length of the small Value data corresponding to the Key. The Multi-Item header of the Multi-Item Container may comprise a header type and a compressed length of the Multi-Item Container. The non-small Value header may comprise a header type, a compressed flag, a CRC, a Key corresponding to the non-small Value data, a compressed length of the non-small Value data and an uncompressed length of the small Value data.

According to an embodiment, the determination of whether to flush the buffer at B74 may comprise determining whether a predetermined number n of small Value data and the small Value headers have been stored in the buffer in memory. In one embodiment, determining to flush the buffer may comprise determining that no additional small Value data have been received and stored in the buffer for a predetermined amount of time (e.g., a timeout period). Determining whether to flush the buffer may also comprise determining that the Key of the received Key-Value data has a match in a small Value header stored in the buffer. For instance, a duplicate Key in the buffer may indicate that the host wrote the same Key twice, in quick succession, or read back a key they just wrote, which may be considered to be anomalous host operations.

According to embodiments, when executing a read command for a small Value data corresponding to a UserKey, the method may further comprise retrieving and decompressing a Multi-Item Container, and reading a decompressed small Value data whose decompressed Small Value Header contains a Key that matches the UserKey. In one embodiment, the size of the Multi-Item Container may be apportioned amongst the small Value data contained in the Multi-Item Container depending upon the uncompressed size of the small Value data contained in the Multi-Item Container. The method may further comprise apportioning the size of the Multi-Item Container evenly amongst the small Value data contained in the Multi-Item Container. In one embodiment, the size of the multi-Item Container may be less than a single read addressable unit. For instance, the size of the multi-Item Container may an integer multiple (e.g., 1, 2 ...) of 8 KB.

Herein, although the terms “prepend” or “prepending” are used in relation to headers, the headers need not be prepended but may be added after the Value data or generally stored at some other location in the multi-Item Container.

Another embodiment is a Key-Value data storage system. The Key-Value storage system may comprise a storage device that is configured to store and enable access to user data via a Key-Value system, a memory, at least one processor and a plurality of processes spawned by the processor(s). The plurality of processes may comprise processing logic to iteratively: receive Key-Value data, the Key-Value data including a Key and a data Value, determine whether the Value data is a small Value data that is smaller than a predetermined threshold or a non-small Value data that is larger than or equal to the threshold; when the Value data is determined to be a small Value data, prepend a small Value header to the small Value data and temporarily store the small Value data and the prepended small Value header in a buffer in the memory, and when the Value data is determined to be a non-small Value data, the non-small Value data is compressed and prepend a non-small Value header to the non-small Value data, generate a single piece of metadata corresponding to the Key and to the non-small Value and send the non-small Value data and the prepended non-small Value header to a media allocator for storage to media in the storage device. Processing logic may be provided to determine whether to flush (transfer the contents out of) the buffer. If the buffer is not to be flushed, the processing logic may then revert back to receiving Key-Value data and subsequent functionality. If the processing logic determined that the buffer is to be flushed, processing logic then compresses, as a single compressed unit, the small Value data and the prepended small Value headers flushed from the buffer, generates and prepends a Multi-Item header to the single compressed unit to form a Multi-Item Container and generates a separate piece of metadata for each small Value data in the Multi-Item Container. The Multi-Item Container may then be sent to the media allocator for storage to the media in the storage device.

Key-Value systems according to embodiments do not suffer from the write and read amplification issues that are endemic to legacy Log Structured Merge solutions. Indeed, LSMs suffer from write amplification issues, occasioned by LSM's repeated rewriting of data during successive compactions, which can shorten the lifespan of SSDs. Moreover, embodiments do not suffer from the read latency issues plaguing LSMs, in which read operations become slower, as the data of interest is often not present in memory, which then requires multiple SSTable lookups. Such read latency issues are also occasioned by the multi-level structure of the SSTables, often requiring lengthy bloom filter search operations. Also, LSM-Trees may not perform as well as simpler algorithms such as B-trees for small datasets due to their design and compaction overhead. Significantly, deploying Multi-Item Containers in Key-Value storage systems according to the embodiments shown and described herein provides the same advantage of compressing multiple small items together without the downsides of Log Structured Merge in which multiple Value data are stored together in a file.

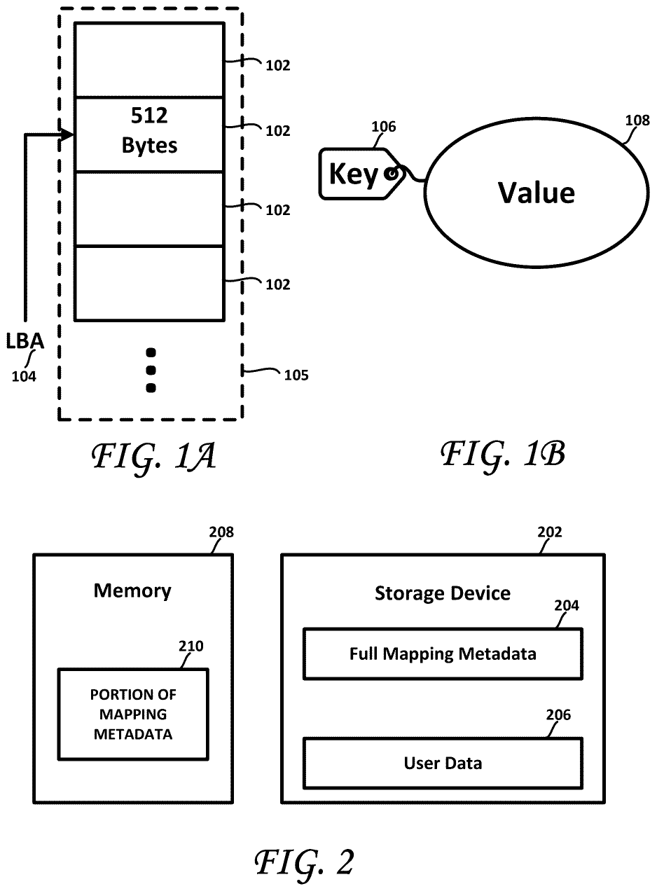

FIG. 8 a computer system configured to execute the computer-implemented methods shown and described herein. According to one embodiment, the computer system may comprise at least storage media 804, 805, 806, at least one processor 808, memory 810 and a network interface 813. A plurality of processes may be spawned by the processor 808, which plurality of processes may comprise processing logic to carry out the computer-implemented methods and functionality shown and described at least relative to FIGS. 1B-7. FIG. 8 also shows exemplary tangible, non-transitory computer-readable media 818 having data stored thereon representing sequences of instructions which, when executed by the computer system, cause the computer system to carry out a computer-implemented method of implementing a Key-Value store system that more efficiently stores small Value data according to one or more of the embodiments described herein.

Discussing now FIG. 8 in greater detail, the computer system may comprise direct access data storage devices such as magnetic disks 804, non-volatile semiconductor memories (EEPROM, Flash, etc.) 806, a hybrid data storage device 805 comprising both magnetic disks 804 and non-volatile semiconductor memories, one or more microprocessors 808 and volatile memory 810. The computer system may also comprise a network interface 813, configured to communicate over network 814 with remote servers, storage services and the like. References 804, 805, 806 and 818 are examples of tangible, non-transitory computer-readable media having data stored thereon representing sequences of instructions or processing logic which, when executed by the computer system, cause the computer system to carry out the computer implemented methods described herein and shown at least relative to FIGS. 1B-7. Some of these instructions may be stored locally in the computer system 802, while others of these instructions may be stored (and/or executed) remotely and communicated to the computer system 802 over the network 814. In other embodiments, all these instructions may be stored locally in the computer system 802, while in still other embodiments, all of these instructions are stored and executed remotely, and the results communicated to the computer system 802. In another embodiment, the instructions may be stored on another form of a tangible, non-transitory computer readable medium, such as shown at 818. For example, reference 818 may be implemented as an optical or magnetic disk, which may constitute a suitable data carrier to load the instructions stored thereon onto the computer system 802, thereby re-configuring the computer system to one or more of the embodiments described and shown herein.

In the foregoing description, numerous specific details are set forth in order to provide a thorough understanding of one or more aspects and/or features of the exemplary embodiments. It will be apparent to one skilled in the art, however, that one or more aspects and/or features described herein may be omitted in favor of others or omitted all together. Herein, each described and/or shown important feature, structure or functionality can be isolated from the others. Thus, individual aspects, features, structures described in relation to one embodiment may be used in, added to, or substituted in in relation to another embodiment. In some instances, the description of well-known process steps and/or structures are omitted for clarity or for the sake of brevity.

Herein, devices or processes that are described as being in communication with each other need not be in continuous communication with each other, unless expressly specified otherwise. In addition, devices or processes that are disclosed to be in communication with one another may communicate directly or indirectly through one or more intermediaries.

Further, although constituent steps of methods have been described in a sequential order, such methods may be configured to work in alternate orders. In other words, any sequence or order of steps that may be described herein does not, in and of itself, indicate a requirement that the steps be performed in that order. The steps of described processes may be performed in an order that differs from the order described herein. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred over other processes.

When a single device or article is described, it will be readily apparent that more than one device/article (e.g., whether or not they cooperate) may be used in place of a single device/article. Similarly, where more than one device or article is described (e.g., whether or not they cooperate), it will be readily apparent that a single device/article may be used in place of the more than one device or article. The functionality and/or the features of a device may be alternatively embodied by one or more other devices that are not explicitly described as having such functionality/features.

Lastly, while certain embodiments of the disclosure have been described, these embodiments have been presented by way of example only and are not intended to limit the scope of the disclosure. Indeed, the novel methods, devices and systems described herein may be embodied in a variety of other forms. Furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all the features and advantages set forth herein, are also within the scope of this disclosure. Accordingly, the scope of the present disclosure is intended to be defined only by reference to the appended claims.

1. A computer-implemented method of implementing a Key-Value store, comprising:
iteratively:
receiving Key-Value data, the Key-Value data including a Key and a Value data;
determining whether the Value data is a small Value data that is smaller than a predetermined threshold or a non-small Value data that is larger than or equal to the threshold;
when the Value data is determined to be a small Value data, prepending a small Value header to the small Value data, and temporarily storing the small Value data and the prepended small Value header in a buffer, and
when the Value data is determined to be a non-small Value data, compressing and prepending a non-small Value header to the non-small Value data, generating a single piece of metadata corresponding to the Key and to the non-small Value and sending the non-small Value data and the prepended non-small Value header to a media allocator for storage to media;
determining to flush the buffer;
compressing, as a single compressed unit, the small Value data and the prepended small Value headers flushed from the buffer;
generating and prepending a multi-item header to the single compressed unit to form a multi-item container;
generating a separate piece of metadata for each small Value data in the multi-item container, and
sending the multi-item container to the media allocator for storage of the multi-item container to media.

2. The computer-implemented method of claim 1, wherein the small Value header comprises a Key corresponding to the small Value data, a Cyclic Redundancy Check (CRC) and an uncompressed length of the small Value data corresponding to the Key.

3. The computer-implemented method of claim 1, wherein the Multi-Item header comprises a header type and a compressed length of the Multi-Item Container.

4. The computer-implemented method of claim 1, wherein the non-small Value header comprises a header type, a compressed flag, a CRC, a Key corresponding to the non-small Value data, a compressed length of the non-small Value data and an uncompressed length of the small Value data.

5. The computer-implemented method of claim 1, wherein determining to flush the buffer comprises determining whether a predetermined number n of small Value data and the prepended small Value headers are stored in the buffer.

6. The computer-implemented method of claim 1, wherein determining to flush the buffer comprises determining that no additional small Value data have been received and stored in the buffer for a predetermined amount of time.

7. The computer-implemented method of claim 1, wherein determining to flush the buffer comprises determining that the Key of the received Key-Value data has a match in a small Value header stored in the buffer.

8. The computer-implemented method of claim 1 wherein, upon executing a read command for a small Value data corresponding to a UserKey, the method further comprises retrieving and decompressing a Multi-Item Container, and reading a decompressed small Value data whose decompressed prepended Small Value Header contains a Key that matches the UserKey.

9. The computer-implemented method of claim 1, further comprising apportioning a size of the Multi-Item Container amongst the small Value data contained in the Multi-Item Container depending upon an uncompressed size of the small Value data contained in the Multi-Item Container.

10. The computer-implemented method of claim 1, further comprising apportioning a size of the Multi-Item Container evenly amongst the small Value data contained in the Multi-Item Container.

11. The computer-implemented method of claim 1, wherein a size of the multi-Item Container is less than a single read addressable unit.

12. The computer-implemented method of claim 1, wherein a size of the multi-Item Container is an integer multiple of 8 KB.

13. A Key-Value data storage system, comprising:
a storage device, the storage device being configured to store and enable access to user data via a Key-Value system;
a memory;
at least one processor;
a plurality of processes spawned by the processor, the plurality of processes comprising processing logic to:
iteratively:
receive Key-Value data, the Key-Value data including a Key and a data Value;
determine whether the Value data is a small Value data that is smaller than a predetermined threshold or a non-small Value data that is larger than or equal to the threshold;
when the Value data is determined to be a small Value data, prepend a small Value header to the small Value data and temporarily store the small Value data and the prepended small Value header in a buffer in the memory, and
when the Value data is determined to be a non-small Value data, compressing and prepend a non-small Value header to the non-small Value data, generate a single piece of metadata corresponding to the Key and to the non-small Value and send the non-small Value data and the prepended non-small Value header to a media allocator for storage to media in the storage device;
determine to flush the buffer;
compress, as a single compressed unit, the small Value data and the prepended small Value headers flushed from the buffer;
generate and prepend a Multi-Item header to the single compressed unit to form a Multi-Item Container;
generate a separate piece of metadata for each small Value data in the Multi-Item Container, and
send the Multi-Item Container to the media allocator for storage of the Multi-Item Container to the media in the storage device.

14. The Key-Value data storage system of claim 13, wherein the small Value header comprises a Key corresponding to the small Value data, a Cyclic Redundancy Check (CRC) and an uncompressed length of the small Value data corresponding to the Key.

15. The Key-Value data storage system of claim 13, wherein the Multi-Item header comprises a header type and a compressed length of the Multi-Item Container.

16. The Key-Value data storage system of claim 13, wherein the non-small Value header comprises a header type, a compressed flag, a CRC, a Key corresponding to the non-small Value data, a compressed length of the non-small Value data and an uncompressed length of the small Value data.

17. The Key-Value data storage system of claim 13, wherein the processing logic to determine to flush the buffer comprises processing logic to determine whether a predetermined number n of small Value data and the prepended small Value headers are stored in the buffer.

18. The Key-Value data storage system of claim 13, wherein the processing logic to determine to flush the buffer comprises the processing logic to determine that no additional small Value data have been received and stored in the buffer for a predetermined amount of time.

19. The computer-implemented method of claim 1, wherein the processing logic to determine to flush the buffer comprises the processing logic to determine that the Key of the received Key-Value data has a match in a small Value header stored in the buffer.

20. The computer-implemented method of claim 1 wherein, upon executing a read command for a small Value data corresponding to a UserKey, processing logic is executed to retrieve and decompress a Multi-Item Container, and to read a decompressed small Value data whose decompressed prepended Small Value Header contains a Key that matches the UserKey.

21. The computer-implemented method of claim 1, further comprising the processing logic to apportion a size of the Multi-Item Container amongst the small Value data contained in the Multi-Item Container depending upon an uncompressed size of the small Value data contained in the Multi-Item Container.

22. The computer-implemented method of claim 1, further comprising the processing logic to apportion a size of the Multi-Item Container evenly amongst the small Value data contained in the Multi-Item Container.

23. The computer-implemented method of claim 1, wherein a size of the multi-Item Container is less than a single read addressable unit.

24. The computer-implemented method of claim 1, wherein a size of the multi-Item Container is an integer multiple of 8 KB.
